(19) United States
(12) Patent Application Publication
(10) Pub. No.: US 2015/0129372 A1
(43) Pub. Date: May 14, 2015

(54) WHEEL CLAMPING DEVICE

(71) Applicant: Phillip Jacobus De Klerk, Nigel (ZA)

(72) Inventor: Phillip Jacobus De Klerk, Nigel (ZA)

(21) Appl. No.: 14/390,740

(22) PCT Filed: Apr. 4, 2012
(86) PCT No.: PCT/ZA2012/000021

§ 371 Date: Jan. 28, 2015

(51) Int. Cl. B60R 25/09; F16D 55/225

(52) U.S. Cl. CPC B60R 25/09; F16D 55/225
USPC 188/72.9

(57) ABSTRACT

The invention relates to a clamping device (0) for a wheel and includes a base configured such that first and second brake pads (13) can be arranged in opposition. The invention includes a connecting member which is configured to be displaced relative to the base such that a force is applied to the first brake pad (13) relatively toward the second brake pad (13). Finally the invention includes a lever (3) arranged oh the base and linked to both the second brake pad and the connecting member and selectively displaceable from an inoperative position to an operative position such that in displacing the lever from the inoperative position to the operative position the second brake pad is displaced relatively toward the first brake pad and in addition the connecting member is displaced relative to the base such that a force is applied to the first brake pad (13) relatively toward the second brake pad (13).

### TECHNICAL FIELD OF THE INVENTION

The invention relates to wheel clamping devices, more specifically devices used to clamp the wheels of trailers.

### BACKGROUND TO THE INVENTION

Wheel clamping devices are typically used to secure a wheel of a trailer in position in order to prevent the trailer from moving freely once positioned.

The inventor is aware of clamping devices that make use of a forward-pull configuration and alternatively the inventor is aware of clamping devices that uses a centre-pull action to clamp the wheel of a trailer.

It is an object of the invention to provide an alternative clamping device to both traditional centre-pull and forward-pull devices.

### SUMMARY OF THE INVENTION

According to a first aspect of the invention there is provided a clamping device for a wheel which includes:

a base configured to be mounted on a vehicle;

first and second brake pads arranged in opposition on the base, with the brake pads in substantially parallel planes and displaceable relatively toward and away from each other;

a connecting member displaceable relative to the base and linked to the first brake pad such that the displacement of the connecting member translates into displacement of the first brake pad relatively toward the second brake pad; and

a lever arranged on the base and linked to both the second brake pad and the connecting member, the lever is selectively displaceable from an inoperative position to an operative position such that in displacing the lever from the inoperative position to the operative position the second brake pad is displaced relatively toward the first brake pad and in addition the connecting member is displaced relative to the base such that a force is applied to the first brake pad relatively toward the second brake pad.

The base may consist of multiple sections or parts, in a preferred embodiment the base consists of a brake pad mounting section attached to a calliper mounting section. The sections or parts are typically attached by means of cap screws but may also be attached by other means such as bolts or another type of screw. The brake pad mounting section is typically configured to have the brake pads mounted in position thereon, whereas the calliper mounting section typically has the connecting member and the lever arranged thereon. In a preferred embodiment the base is configured to, in use, straddle a brake disc, with the brake pads positioned on opposing sides of the brake disc. It is to be appreciated that when the brake pads on opposing sides of the brake disc are displaced relatively toward one another the brake disc is retained between the brake pads.

The connecting member may take the form of urging element such as a substantially C-shaped C-arm. The C-arm may be connected to the base by means of a pivot such as a transverse pin or calliper pin. The connecting member may be arranged in direct contact with the first brake pad. Alternatively an intermediate block may be included between the connecting member and the first brake pad in order to distribute the force applied by the connecting member onto the first brake pad. The inventor believes that by distributing the force, the mechanical wear on both the first brake pad and the connecting member can be reduced. It is to be appreciated that the angular displacement of the lever results in the C-arm pivoting about the calliper pin, with the end of the C-arm relatively distant to the lever moving closer to the lever.

The lever may be configured to apply a force directly to the second brake pad, the device, however, typically includes a knuckle configured to relate the movement and force of the lever to the second brake pad. An intermediate block may also be included between the knuckle and the second brake pad in order to distribute the force applied by the lever onto the second brake pad. The knuckle may be located at the pivot or fulcrum of the lever, in order to translate the angular displacement at the pivot into a substantially linear force applied on either the second brake pad or the connecting member. The knuckle may be attached to the base by means of the calliper pin or transverse pin.

The lever may be an elongate rod or bar, typically in the form of a straight rod or flat bar, alternatively the lever may be substantially arcuate in shape and may take the general shape of a hook or a crook in order to facilitate manual substantially horizontal displacement of the lever. A lever in the form of an elongate rod or bar may be configured to receive a lever extension. The lever extension is typically provided in order to convert the straight lever into a hooked embodiment. The lever and lever extension may be provided with coinciding apertures configured to facilitate the securing of the lever extension by means of pins, such as clevis pins which may be held in place by split pins.

The device may include a brake disc configured to be attached to a wheel of the vehicle.

According to a second aspect of the invention there is provided a lever extension configured to extend the lever of a device substantially as described above.

According to a third aspect of the invention there is provided an intermediate block for use in a device substantially described as above, which is configured to distribute the force applied on the brake pads.

The intermediate block may be located between the lever and the second brake pad and/or between the connecting member and the first brake pad.

According to a fourth aspect of the invention there is provided a clamping device for a wheel which includes:

a mounting base configured to be mounted on a vehicle and which mounting base includes mounting means such that two brake pads can be mounted in opposition thereon, with the brake pads deplaceable relatively toward and away from each other;

a lever attached to a camshaft and a cam, with both the lever and the cam arranged on the mounting base such that angular displacement of the lever is translated into linear displacement of a first brake pad relatively toward a second brake pad by means of the cam; and

a connecting member linking both the second brake pad and the lever such that angular displacement of the lever results in linear displacement of the second brake pad relatively toward the first brake pad by means of the connecting member.

Intermediate blocks may be provided in between the connection of the cam to the first brake disc. Similarly an intermediate block may be provided between the connecting member and the second brake pad. The intermediate block is configured to distribute the force applied by the connecting member and/or cam onto a brake pad.

### BRIEF DESCRIPTION OF THE DRAWINGS

The invention will now be described by way of non-limiting example with reference to the accompanying drawings.

In the drawings:

FIG. 1 shows an exploded view of a wheel clamping device, in accordance with the invention;

FIG. 2 shows a side view of the device engaging a brake disc;

FIG. 3 shows a top view of the device in FIG. 1;

FIG. 4 shows a top view of the device with a lever extension attached; and

FIG. 5 shows a side view of the device seen in FIG. 4

### DETAILED DESCRIPTION OF THE INVENTION

With reference to the drawings the wheel clamping device, in accordance with the invention is generally depicted by reference numeral 0.

The device 0 includes a base consisting of a calliper mounting section 1 and a brake pad mounting section 2. The brake pad mounting section 2 is configured to have two brake pads 13 arranged in opposition thereon by means of a guide pin 5 and a cap screw 8. The guide pin 5 and cap screw 8 is also used to attach the calliper mounting section 1 to the brake pad mounting section 2.

The device 0 includes a connecting member in the form of a substantially C-shaped C-arm 7 attached to the calliper mounting section 1 by means of a pivot in the form of a calliper pin 6. The C-arm 7 is configured to apply a force to one of the brake pads 13 when angularly displaced relative to the calliper mounting section 1 about the calliper pin 6.

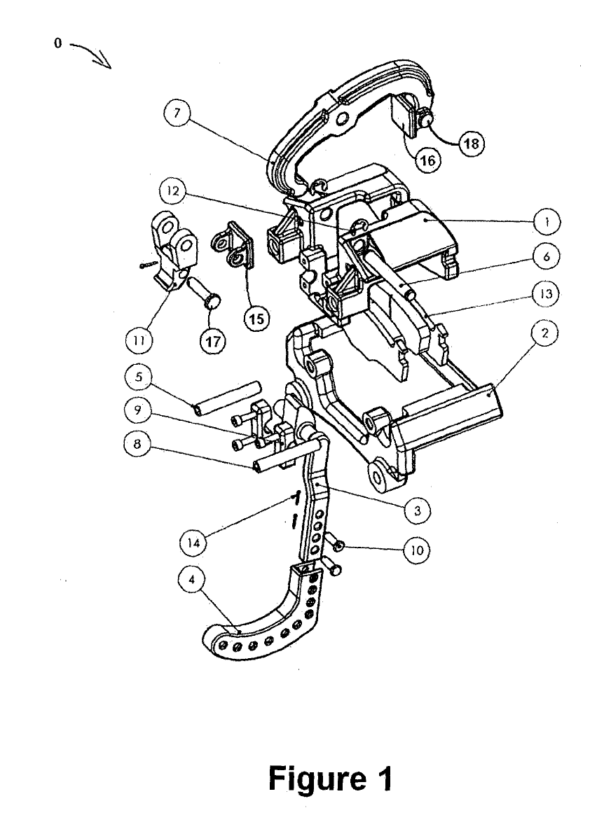

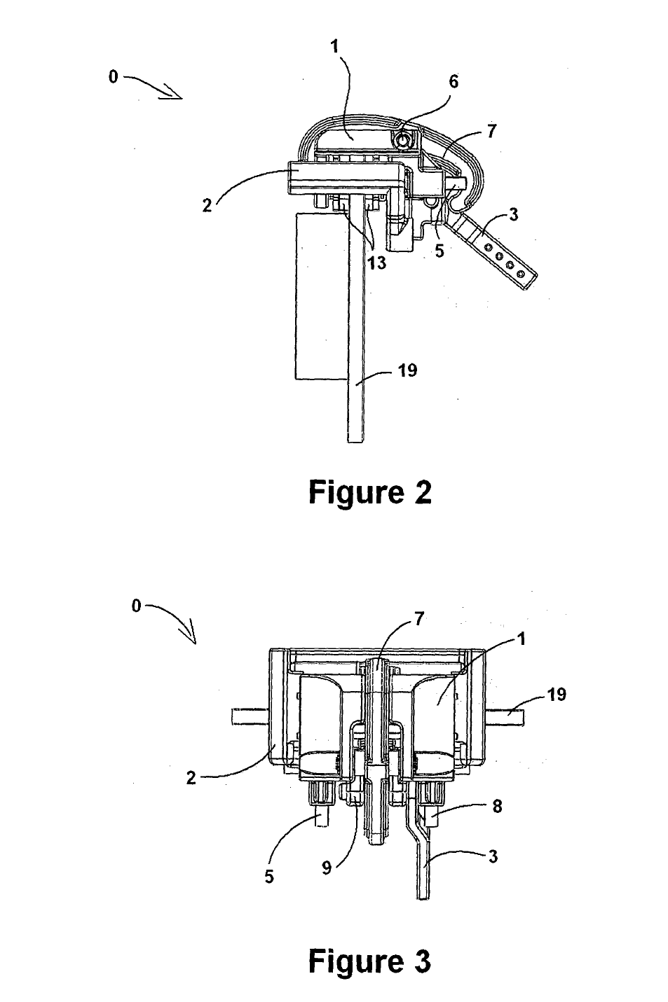

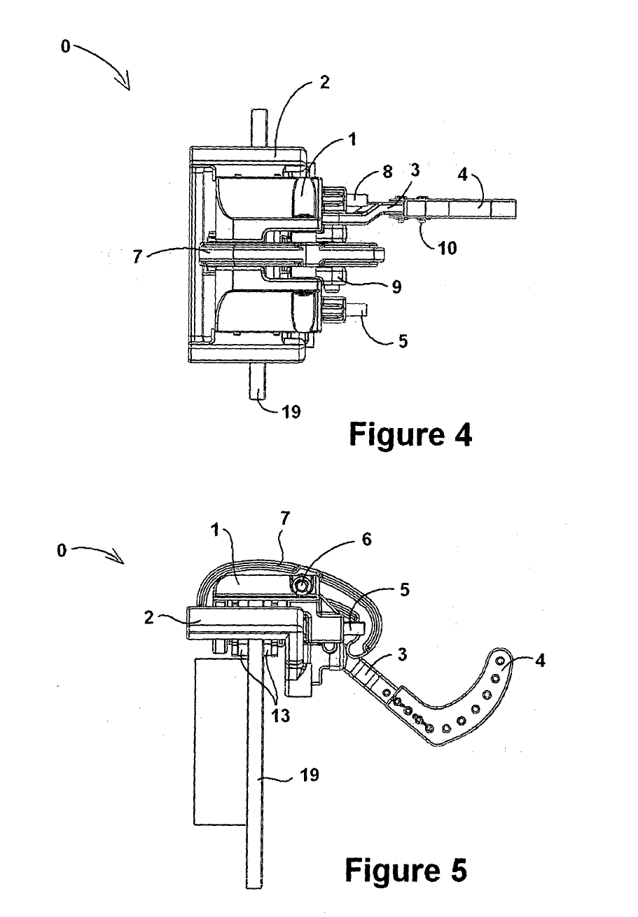

A lever 3 is arranged on the calliper mounting section 1 by means of clamps 9 and is linked to one of the brake pads 13 via a knuckle 11. The lever 3 is also connected to the c-arm 7. The lever 3 is selectively displaceable between and inoperative position typically as seen in FIG. 1 and an operative position as shown in FIGS. 2 through 5. When the lever 3 is displaced from the inoperative position to the operative position one of the brake pads 13 is forced relatively toward the other by means of the knuckle 11 in conjunction with an intermediate block in the form of a first distributing shoe 15. Similarly when the lever 3 is displaced from the inoperative position to the operative position one of the brake pads 13 is forced relatively toward the other through the movement of the C-arm 7 relative to the calliper mounting section 1. The force applied by the C-arm 7 onto the brake pad 13 is also distributed by means of a second distributing shoe 16.

The first distributing shoe is attached to the knuckle by means of pin 17 and the second distributing shoe is attached to the C-arm by means of pin 18.

In use, as seen in FIGS. 2 through 5 the brake mounting section 2 partially straddles a brake disc 19 with the brake pads 13 on opposing sides of the brake disc 13. By forcing the brake pads 13 relatively toward one another through displacing the lever 3, the brake disc 19 is frictionally retained between the two brake pads 13

The lever 3 is in the form of a flat bar and is configured to have lever extension 4 attached thereto. The lever 3 and lever extension 4 each has coinciding apertures defined thereon in order to facilitate attachment. The lever extension 4 is attached to the lever 3 by inserting clevis pins 10 through the coinciding apertures and the clevis pins are retained by means of split pins 14.

It is to be appreciated that a lubricant injector in accordance with the invention is not limited to the precise constructional and functional details as set out herein.

1. A clamping device for a wheel which includes:
a base configured to be mounted on a vehicle;
first and second brake pads arranged in opposition on the base, with the brake pads in substantially parallel planes and displaceable relatively toward and away from each other;
a connecting member displaceable relative to the base and linked to the first brake pad such that the displacement of the connecting member translates into displacement of the first brake pad relatively toward the second brake pad:
and
a lever arranged on the base and linked to both the second brake pad and the connecting member, the lever is selectively displaceable from an inoperative position to an operative position such that in displacing the lever from the inoperative position to the operative position the second brake pad is displaced relatively toward the first brake pad and in addition the connecting member is displaced relative to the base such that a force is applied to the first brake pad relatively toward the second brake pad.

2. A clamping device as claimed in claim 1 wherein the connecting member takes the form of a substantially C-shaped C-arm.

3. A clamping device as claimed in claim 1 which includes a knuckle that is configured to relate the displacement of the lever into displacement of the second brake pad relatively toward the first brake pad.

4. A clamping device as claimed in claim 3 wherein the knuckle is configured to relate the displacement of the lever into angular displacement of the connecting member relative to the base.

5. A clamping device as claimed in claim 3 wherein both the knuckle and the connecting member connected to the base by means of a pivot, such that angular displacement of the lever results in displacement of both the knuckle and the connecting member resulting in the displacement of the brake pads relatively toward each other.

6. A clamping device as claimed in claim 5, which includes a lever extension, attached to the lever in order to assist gripping the lever when applying a force.

7. A clamping device as claimed in claim 6 wherein the lever extension is substantially arcuate in shape.

8. A clamping device as claimed in claim 7, wherein the force applied on the second brake pad is generally distributed by means of an intermediate block.

9. A clamping device as claimed in claim 8, wherein a force applied to the first brake pad is generally distributed by means of an intermediate block.

10. A clamping device as claimed in claim 8, wherein the intermediate block takes the form of a pressure distributing shoe.

11. A clamping device for a wheel which includes:
a mounting base configured to be mounted on a vehicle wherein the mounting base includes mounting means such that two brake pads can be mounted in opposition thereon, with the brake pads displaceable relatively toward and away from each other;
a camshaft and a cam configured to be rotated by means of a lever, with camshaft and cam arranged on the mounting base such the angular displacement of the lever is translated into linear displacement of a first brake pad relatively toward a second brake pad via the rotation of the cam; and
a connecting member linking both the second brake pad and the lever such that angular displacement of the lever results in linear displacement of the second brake pad relatively toward the first brake pad by means of the connecting member.

12. (canceled)
